(19) United States
(12) Patent Application Publication
(10) Pub. No.: US 2026/0215443 A1
(43) Pub. Date: Jul. 30, 2026

(54) AUTOMATIC CONTINUOUS POULTRY TENDERLOIN REMOVAL

(71) Applicant: JBT Marel Corporation, Chicago, IL (US)

(72) Inventors: Cezary J. Mroz, Lewis Center, OH (US); Barry K. Jones, Columbus, OH (US); Cameron L. Logan, Buckeye Lake, OH (US)

(73) Assignee: JBT Marel Corporation, Chicago, IL (US)

(21) Appl. No.: 19/143,585

(22) PCT Filed: Dec. 13, 2023
(86) PCT No.: PCT/US2023/083889

§ 371 Date: Jun. 26, 2025

Related U.S. Application Data
(60) Provisional application No. 63/477,697, filed on Dec. 29, 2022.

(51) Int. Cl. A22C 21/00

(52) U.S. Cl. CPC A22C 21/003

(57) ABSTRACT

A poultry processing machine (100) includes a tenderloin removal station (106) where removal assemblies (180) are located along each side of a frame structure (108). The tenderloin removal assembly (180) includes multiple jaw sets (182) that continuously rotate about a vertical axis (184) to align (index) with the tenderloin (190) of a poultry carcass (125) that is transported by the removal station (106) by the cone line (120). The rotating jaw set (182) closes over a tenderloin (190) and then peels the tenderloin away from the carcass (125) as the cone line (120) continues to move downstream and the closed jaw set (182) rotates away from the carcass. WO

### CROSS-REFERENCE TO RELATED APPLICATION

This application clams the benefit of U.S. Provisional Application No. 63/477697, filed Dec. 29, 2022, the entire contents of which are incorporated herein by reference.

### BACKGROUND

The present disclosure pertains to the automated and continuous removal of breast tenderloins from a poultry carcass. In the past, the harvesting of poultry breast tenderloins, and chicken breast tenderloins in particular, has largely been performed manually. The process of manually harvesting tenderloins, commonly referred to as “tenders,” from a poultry carcass typically involves several preparatory steps before the eventual manual stripping of the elongated tenders from the carcass. These steps commonly include separating or folding away the wishbone of the carcass from the upper portions of the tenders, followed by severing or cutting the tendons that connect the ends of the tenders to the adjacent anatomical structures, including the rib cage near the shoulder and the keel or sternum. In addition, plow devices are scraped along the keel to sever or loosen the tenderloin from the keel. Once prepared in this manner, the tenders are pulled away from the carcass through the application of at least a moderate level manual force. The cold operating environment, typically about 40 degrees F., repetitive nature of the tender removal, as well as the speed at which this operation must be carried out make it difficult to staff this production position.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, an apparatus for removing tenderloins from a poultry carcass is provided, the carcass being transported by a conveyance system past a processing station where the tenderloins are removed from the carcass. The apparatus includes: at least one jaw set; a mounting structure for supporting the at least one jaw set for moving the at least one jaw set in an arcuate path towards and then away from the poultry carcass; and an actuator operable on the at least one jaw set to cause the at least one jaw set to be in open configuration when the at least one jaw set moves toward the moving carcass and then to close the at least one jaw set over the tenderloin to detach the tenderloin from the carcass as the at least one jaw set moves away from the carcass while traveling in the arcuate path.

In any of the embodiments described herein, wherein the mounting structure places the moving at least one jaw set in registry with the poultry tenderloin when the carcass is passing by the processing station.

In any of the embodiments described herein, wherein the mounting structure moves the at least one jaw set towards the carcass as the carcass approaches the processing station.

In any of the embodiments described herein, wherein the mounting structure moves the at least one jaw set away from the carcass as the carcass moves away from the processing station.

In any of the embodiments described herein, wherein the actuator continuously moves the at least on jaw set in the arcuate path.

In any of the embodiments described herein, wherein the actuator opens the at least one jaw set to release tenderloin that has been grasped by the at least one jaw set and removed from the carcass.

In any of the embodiments described herein, further comprising a plurality of jaw sets operable to remove tenderloins from respective carcasses.

In any of the embodiments described herein, wherein the plurality of jaw sets sequentially remove tenderloins from respective carcasses.

In any of the embodiments described herein, wherein the mounting structure continuously pivots about a central axis, and the jaw sets are disposed radially relative to the central axis.

In any of the embodiments described herein, wherein the actuator pivots about the central axis to remain in position to be operable on a respective jaw set.

In any of the embodiments described herein, wherein the jaw sets are spaced about the mounting structure.

In any of the embodiments described herein, wherein the mounting structure pivots about a central axis, and the at least one jaw set is disposed radially relative to the central axis.

In any of the embodiments described herein, wherein the actuator pivots about the central axis to remain in position to be operable on the at least one jaw set.

In any of the embodiments described herein, wherein the actuator includes a cam system and a cam follower system operated on by the cam system to open and close the at least one jaw set.

In any of the embodiments described herein, wherein the cam system is stationary, and the cam follower system is disposed between the cam system and the at least one jaw set to open and close the jaw as the mounting structure pivots about the central axis.

In any of the embodiments described herein, wherein the at least one jaw set includes a first jaw grip and a second jaw grip, and the actuator includes a first cam and a first cam follower disposed between the first cam and the first jaw grip to move the first jaw grip toward and away from the second jaw grip.

In any of the embodiments described herein, wherein the actuator comprises a second cam and a second cam follower disposed between the second cam and the second jaw grip to move the second jaw grip toward and away from the first jaw grip.

In any of the embodiments described herein, wherein the second cam is stationary, and the second cam follower is mounted on the mounting structure to open and close the second jaw grip as the mounting structure rotates about the central axis.

In any of the embodiments described herein, wherein the first cam is stationary, and the first cam follower is mounted on the mounting structure to open and close the first jaw grip as the mounting structure rotates about the central axis.

In any of the embodiments described herein, wherein the first cam is stationary, and the first cam follower is mounted on the mounting structure to open and close the first jaw grip as the mounting structure rotates about the central axis.

In any of the embodiments described herein, wherein the first and second cams are stationary, and the first and second cam followers are mounted on the mounting structure to open and close the first and second jaw grips, respectively, as the mounting structure rotates about the central axis.

In accordance with another embodiment of the present disclosure, an apparatus for removing tenderloins from a poultry carcass is provided, the carcass being transported by a conveyance system past a processing station where the tenderloins are removed from the carcass. The apparatus includes: at least one jaw set; a mounting structure for supporting the at least one jaw set and for moving the at least one jaw set along an arcuate path, towards and then away from the poultry carcass; an actuator operable on the at least one jaw set to cause the at least one jaw set to be in open configuration when the at least one jaw set moves toward the moving carcass and then to close the at least one jaw set over the tenderloin; the mounting structure moving the closed at least one jaw set away from the carcass along the arcuate path to peel the tenderloin away from the carcass.

An apparatus in accordance with another embodiment of the present disclosure, wherein the actuator continuously moves the at least one jaw set in the arcuate path.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an isometric view of the tenderloin removal system of the present disclosure;

FIG. 2 is an enlarged isometric view of a portion of FIG. 1;

FIG. 3 is a further enlarged isometric view of a portion of FIG. 2;

FIG. 4 is an elevational view of a portion of FIG. 1;

FIG. 5 is a plan view of a portion of FIG. 4;

FIG. 6A is an isometric view illustrating the removal of tenderloins from a carcass;

FIG. 6B is a view similar to FIG. 6A showing the removal of the tenderloins from a carcass later in time than shown in FIG. 6A;

FIG. 7A is an enlarged partial cross-sectional view illustrating the construction and operation of a jaw set, with the jaw set shown in open position;

FIG. 7B is a view similar to FIG. 7A showing the jaw set in closed position;

FIG. 8 is a plan view illustrating the cam plates of the present disclosure.

### DETAILED DESCRIPTION

The present disclosure provides systems and methods for the automated removal of poultry tenderloins from the poultry carcass as the carcasses travel along a production line. The tenderloin removal system may be incorporated into poultry processing machines wherein previously or subsequently other muscle components are separated from the poultry carcass. Alternatively, the tenderloin removal system may be a standalone assembly.

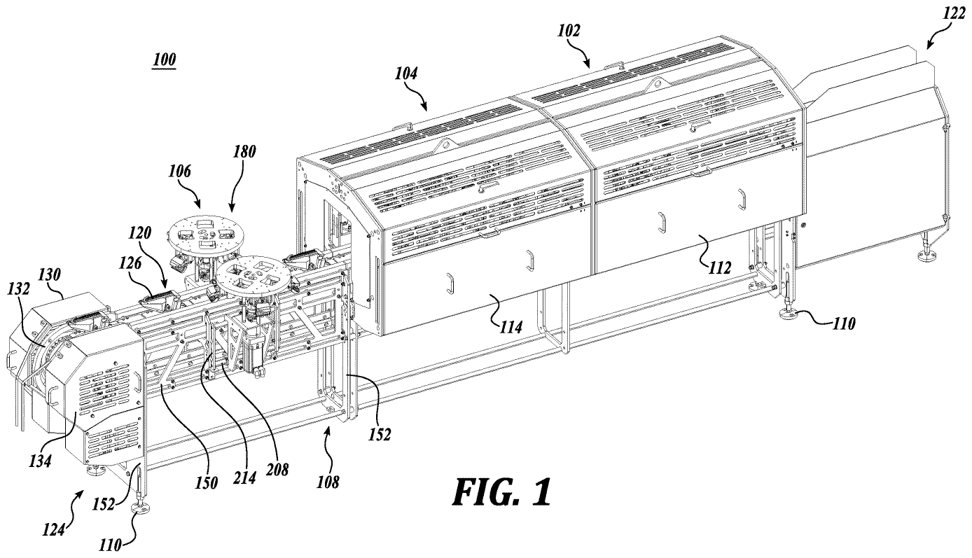

FIG. 1 illustrates an exemplary automated tenderloin removal machine 100 that includes upstream processing stations 102 and 104 where the poultry carcass is preprocessed so as to make the automated removal of the tenderloin feasible. The automated and continuous removal of the tenderloins occurs downstream of stations 102 and 104, at removal station 106. As noted above, such preprocessing at stations 102 and 104 includes moving or folding the wishbone upwardly away from the upper portions of the tenderloin. Also, the tendons at the ends of the tenderloin are cut with a powered blade to detach the tenderloin from the rib cage near the shoulder of the poultry and also detach from the keel. In addition, one or two plow devices are positioned to scrape along the keel bone to peel the tenderloin away from the keel bone. These processing steps are described in U.S. Pat. No. 8,535,124, which is incorporated by reference into this application. Once these processing steps have been completed, the tenderloin is in condition to be removed from the carcass in an automated and continuous fashion, as described below.

The machine 100 includes a longitudinal frame structure 108 which is supported by adjustable feet 110. The feet 110 can be replaced by rollers to facilitate movement of the machine 100 from place to place as desired, for example, to be in alignment to receive partially disassembled carcasses from an up-stream processing machine or apparatus. For example, the up-stream machine may have removed the breasts from the poultry carcass, thereby leaving the tenderloin sufficiently accessible to be removed in accordance with the present disclosure.

As seen in FIG. 1, the processing stations 102 and 104 are enclosed within protective hoods 112 and 114 so as to prevent access to the stations 102 and 104 during operation of the machine 100. A similar hood, not shown, is utilized at removal station 106, but that hood has been removed so as to be able to view the structure and operation of the removal station.

The poultry processing machine 100 may include a conventional cone line 120 for transporting poultry carcasses 125 along the machine's stations from an entry end 122 and an exit end 124. Before reaching the entry end 122, the poultry carcass 122, which may be chicken, capon, turkey, Cornish hen, grouse, quail, duck, goose, or any other bird, is disposed on an upwardly oriented fixture, such as a cone 126 which fits inside the rib cage, with the breasts facing upstream and the back facing downstream. Downstream is the direction the cones move toward (the leftward direction in the orientation of FIG. 1).

The cones 126 are equally spaced apart from each other along a cone conveyor 128 that is mounted to the frame structure 108 to run along the top of the frame structure. The cone conveyor is powered by drive system 130 located at the exit end 124 of the machine 100. The drive system includes a drive sprocket or drive drum 132 about which the cone conveyor is wrapped to be driven. The drive sprocket is, in turn, driven by a drive motor located within housing 134.

The frame structure 108 is composed of vertical side walls 150 that span longitudinally between upright leg structures 152. The side walls, rather than being of solid construction, can be of “open” construction to reduce the weight and material requirements of the frame without compromising its strength and rigidity. Of course, the frame can be of other constructions.

The poultry processing machine 100 at removal station 106 includes a tenderloin removal assembly 180 located along each side of the frame structure 108. As explained in more detail below, the tenderloin removal assembly 180 includes multiple jaw sets 182 that continuously rotate about a vertical axis 184 to align (index) with the tenderloin 190 of a poultry carcass 125 that is transported by the removal station 106 by the cone line 120. The jaw set 182 closes over a tenderloin 190 and then peels the tenderloin away from the carcass 125 as the cone line 120 continues to move downstream and the closed jaw set 182 rotates away from the carcass.

The jaw sets 182 are mounted to the underside of a circular rotating mounting plate 192. The mounting plate is positioned above and to the side of the cone line 120 by a vertical drive shaft 194 that is powered by a motor 196 that is attached to the underside of a platform 198, which in turn is attached to the upper ends of side brackets 200, which in turn is mounted to the frame side walls 150 by additional structures described below. The platform 198 includes downwardly turned side flanges 202 that are constructed with slots 204 for receiving hardware members therein. This enables the “lateral” position of the mounting plate 192 to be adjusted in the direction toward and away from the longitudinal center of the cone line 120, for example, depending on the type and size of the poultry being processed.

While in most instances, once the lateral position of the mounting plate 192 has been adjusted and set in place, no further lateral adjustment of the mounting plate is required during the processing of the poultry in question. However, it is to be understood that the lateral position of the mounting plate 192 can be continuously or periodically adjusted by use of an actuator to shift the platform 198 toward and away from the longitudinal center of the cone line 120, as needed or desired. In this regard, the mounting plate 192 can be mounted on a slide way or rack and gear system or other system in a well-known manner, and a powered actuator, for example, a linear or rotary actuator, is used to move the mounting plate toward and away from the longitudinal center of the cone line 120.

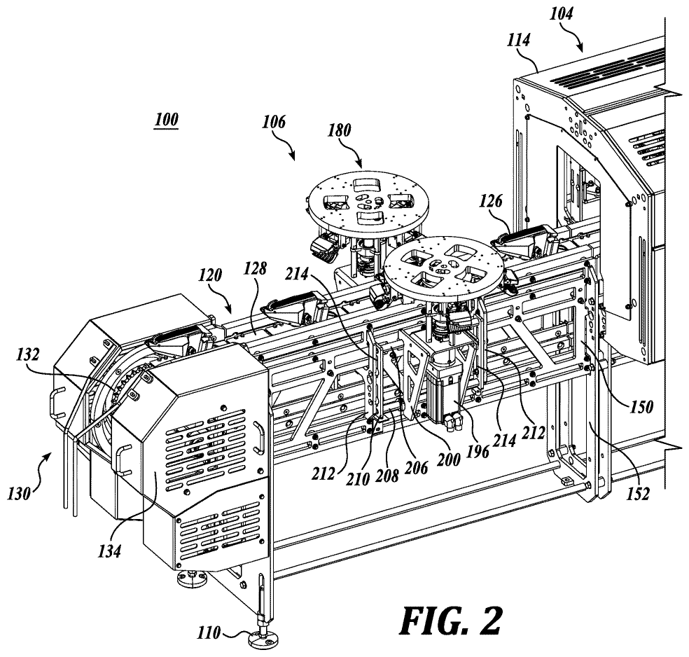

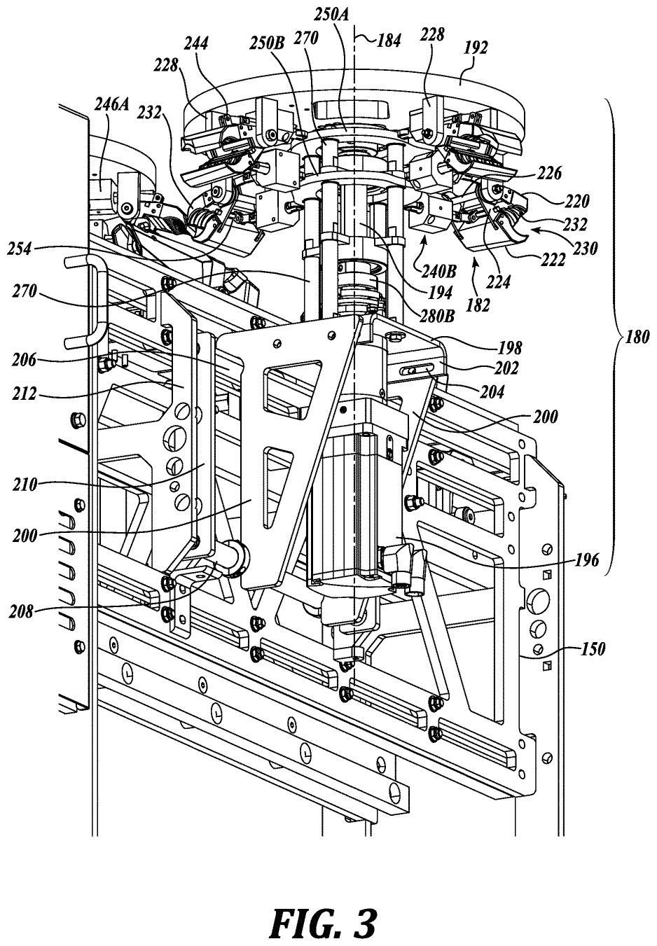

Referring specifically to FIGS. 2 and 3, the upper and lower ends of the side brackets 200 are attached to upper and lower mounting tubes 206 and 208. The ends of the mounting tubes 206 and 208 are attached to the upper and lower ends of upright bar brackets 210. The bar brackets 210 are in turn attached to the vertical sections for “H” brackets 212 that are fixed to the exterior surfaces of the two sidewalls 150 on opposite sides of the frame structure 108. It can be appreciated that the “H” brackets 212 add rigidity and stiffness to the frame structure 108, especially in the region of the tenderloin removal assemblies 180.

Slots 214 are formed in the bar brackets 210 to enable the mounting plate 192, and thereby the jaw sets 182, to be vertically adjusted. While in most instances, once the vertical position of the mounting plate 192 has been adjusted and set in place, no further vertical adjustment of the mounting plate is required during the processing of the poultry in question. However, it is to be understood that the vertical position of the mounting plate 192 can be continuously or periodically adjusted by use of an actuator to shift the bar brackets 210 up or down, as needed or desired. In this regard, the bar brackets 210 can be mounted to the H brackets 212 using a slide way or other relative movement structure in a known manner, and a powered rotary or linear actuator used to adjust the bar brackets up and down.

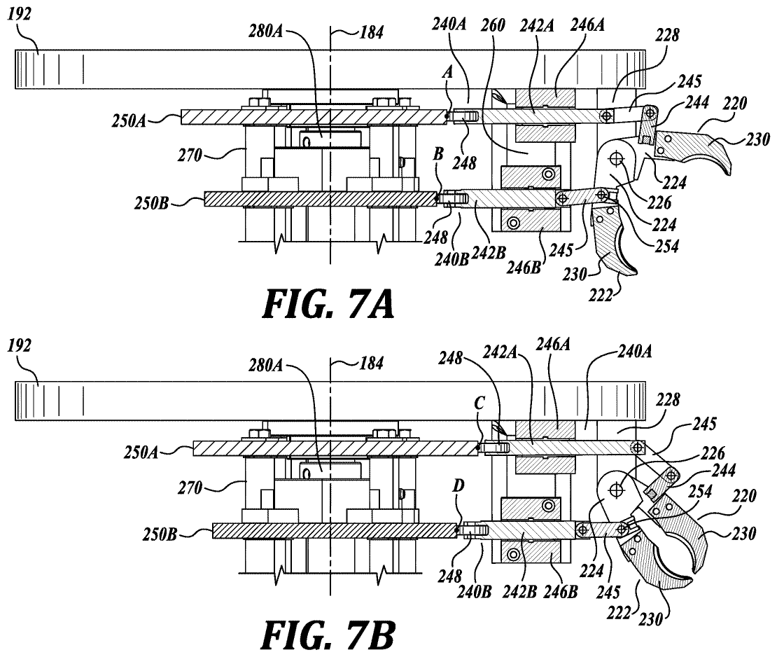

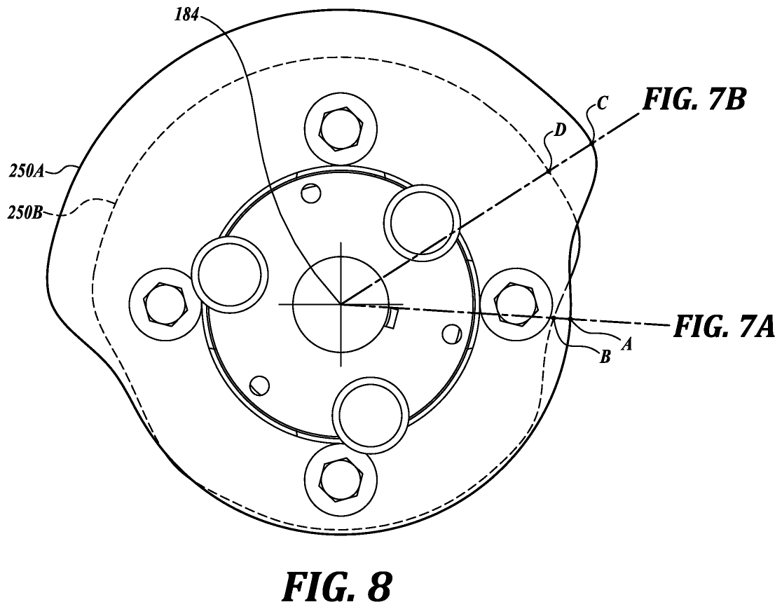

Referring specifically to FIGS. 3, 6A, 6B, 7A, and 7B, each of the jaw sets 182 includes an operable, formed upper jaw grip 220 and an operable, formed lower jaw grip 222. Each jaw grip includes a rearward portion composed of side arms 224 that are rotatably engaged over a pivot pin 226 to enable upper and lower grips 220 and 222 to open and close the jaw set. The ends of pivot pin 226 extending outward of the jaw grips 220 and 222 engage and are supported by hanger brackets 228 that depend downwardly from the underside of the mounting plate 192.

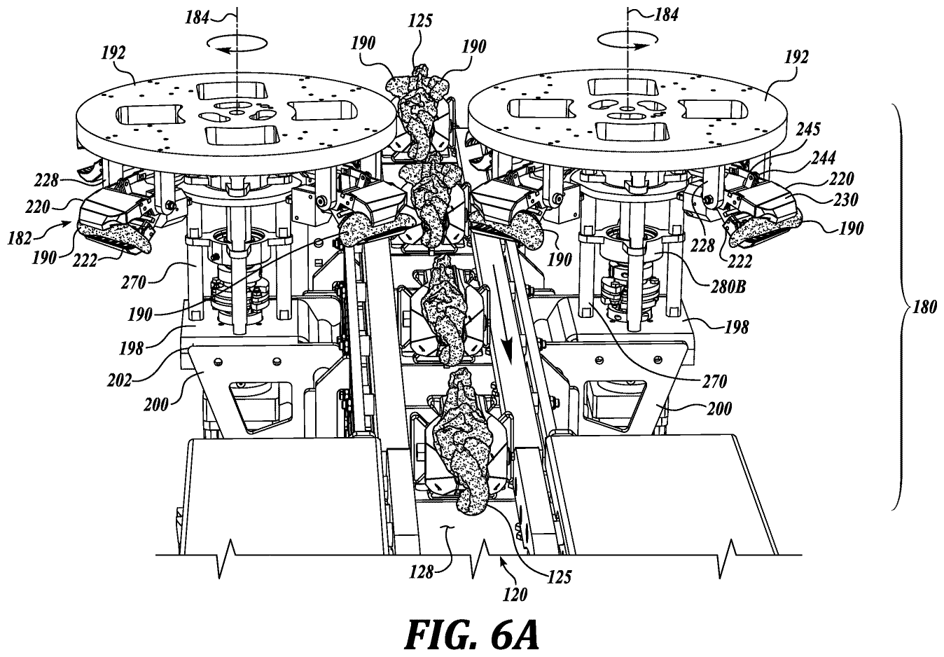

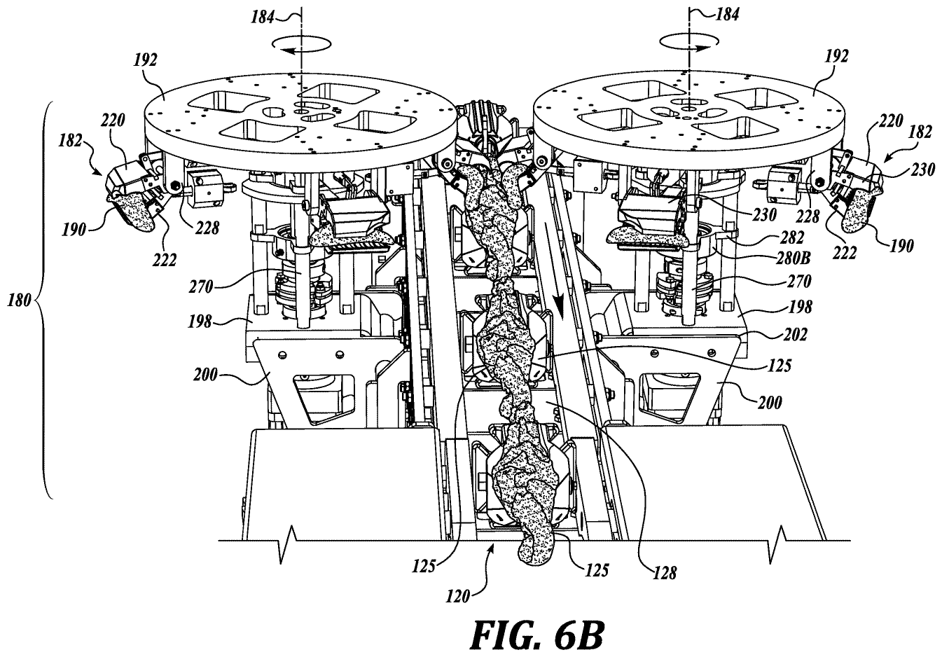

Each jaw grip 220 and 222 also includes a forward jaw portion 230 to which the side arms 224 are attached. The forward jaw portions 230 have an actuate interior configuration extending transverse to the width of the jaw portion so that when the jaw set 182 is closed, the forward jaw portions close around the exterior of the tenderloin 190 to encircle the tenderloin with sufficient tightness and firmness to be able to peel the tenderloin away from the carcass 125. In this regard, see FIGS. 6A and 6B. Optionally, to enhance the gripping ability of the jaw sets 182, raised ridges 232 are provided to extend around the curved surfaces of the jaw portion interior 230. These ridges 232 help grip the tenderloins and help prevent the tenderloins from moving or slipping lengthwise within the jaw grips 220 and 222.

Four jaw sets 182 are shown as positioned about the perimeter of the mounting plate 192 so as to continuously rotate about vertical axis 184. As such, the jaw sets are spaced radially apart 90 degrees from each other about the vertical axis 184. It is to be understood that depending on the configuration of the machine 100, a larger number, or a smaller number, of jaw sets 182 may be utilized. In the present situation, the use of four jaw sets 182 coupled with the speed of rotation of the mounting plate 192 enables a jaw set to correctly index with the carcasses 125 that are transported by the cone line 120.

If the speed of the cone line is changed, then the rotational speed of the mounting plate 192 can be automatically correspondingly changed by a control system 300, as discussed more fully below. In this manner, the jaw sets 182 will remain in synchronization with the locations of the tenderloins 190 on the carcasses 125.

The jaw sets 182 are operated (opened and closed) by cam operated actuators 240A and 240B to operate the upper jaw grip 220 and the lower jaw grip 222, respectively. Each actuator 240A and 240B includes an upper push rod 242A and a lower push rod 242B. The forward end of the upper push rod 242A is connected to parallel mounting ears 244 extending upwardly from the exterior of the upper jaw grip 220 by a pivot link 245. The ends of the pivot link 245 are pinned to the forward end of the upper push rod 242A and the mounting ears 244.

The intermediate section of the upper push rod 242A is closely receivable within an upper guide and support block 246A that is attached to the underside of the mounting plate 192. The upper guide and support block 246A retains the upper push rod 242A in fix orientation relative to an upper cam place 250A.

A roller 248 is axled to the rearward or proximal end of the upper push rod 242A to ride against (roll along) the exterior perimeter edge of the upper cam plate 250A. A spring, not visible, is provided to bias the upper push rod 242A rearwardly against the upper cam plate 250A. As noted above, the upper guide and support block 246A functions to maintain the upper push rod 242A in a correct location relative to the upper jaw grip 220 and the upper cam plate 250A.

The forward end of the lower push rod 242B is connected to the side arms 224 of the lower jaw grip 222 with the pivot link 245. The ends of the pivot link 245 are pinned to the forward end of the lower push rod 242B and also pinned to a cross rod 254 that spans between the side arms 224.

A roller 248 is axled to the rearward or proximal end of the lower push rod 242B to ride against (roll along) the exterior perimeter edge of a lower cam plate 250B. A spring, not visible, is provided to bias the lower push rod 242B rearwardly against the lower cam plate 250B.

The intermediate section of the lower push rod 242B is closely receivable within a lower guide and support block 246B that is attached to a bracket 260 that extends downward from the underside of mounting plate 192. The lower guide and support block 246B functions to maintain the lower push rod 242B in correct location relative to the lower jaw grip 222 and the lower cam plate 250B. Of course, the lower guide and support plate can be mounted in place by other means, such as, for example, by attachment to the upper guide and support block 246A.

The cam plates 250A and 250B are mounted to columns 270 that extend upwardly from platform 198 in spaced parallel relationship to each other. Referring specifically to FIG. 8, the exterior of perimeters of the cam plates 250A and 250B are contoured to push against the rollers 248 of the push rods 242A and 242B to close the open upper and lower jaw grips 220 and 222 at the correct time so as to grasp a tenderloin 190 as the rotational location of a jaw set 182 about axis 184 coincides with a tenderloin 190, being carried on the cone line 120, that is approaching the removal station 106, to thereby peel the tenderloin from its carcass 125. The exterior perimeters of the cam plates 250A and 250B are also contoured to open the upper and lower jaw grips at the correct time to deposit the removed tenderloin 190 into an underlying bin, take away conveyor, or other repository for further processing. Typically, but not essentially, the upper and lower jaw grips would be open when the mounting plate 192 as rotated so that the jaw grips holding the tenderloin 190 are approximately 180 degrees from the cone line 120.

Referring specifically to FIGS. 2, 3, 4, 6A, and 6B, upper and lower roller bearing assemblies 280A and 280B are interposed between the columns 270 and the vertical drive shaft 194. In this regard, mounting wings 282 extend radially outwardly from the outer race structure of the bearing assemblies 280A and 280B to engage around the columns 270 for secure attachment to the columns. The inner race structure of the bearing assemblies closely engage around the drive shaft 194. It can be appreciated that by this construction, a rigid and stable tenderloin removal assembly 180 is achieved. Of course, the tenderloin removal assembly can be constructed in ways other than specifically described above and still perform the needed function of the assembly.

In operation of the machine 100, carcasses 125 are continuously moved along the machine by the cone line 120, with the carcasses being carried on cones 125. As discussed above, the tenderloins 190 have been pre-processed at the processing stations 102 and 104 to sever the tendons between the tenderloins and the rib cage at the wishbone end of the tenderloin and the tendons between the tenderloins and the keel at the other end of the tenderloin. Also, plows or scrapers are used to seek to detach the tenderloin form the keel, along the length of the tenderloin.

The position of the jaw sets 182 is adjusted to match the type and also optionally the size of the poultry being processed. As discussed above, the position of the platform 198 toward and away from the longitudinal centerline of the cone line 120 can be adjusted. Also, the vertical position of the jaw sets 182 can be adjusted by moving the bar brackets 210 up or down relative to the “H” brackets 212.

The rotational speed of the mounting plate 192, and thus the rotational speed of the jaw sets 182, is matched to the longitudinal speed of the cone line so that as a carcass 125 approaches the removal station 106, a jaw set is rotating into tangential alignment with the tenderloin 190 of the carcass. Once the jaw set is positioned over the tenderloin, the upper and lower jaw grips 220 and 220 are closed by the actuators 240A and 240B as operated on by the upper and lower cam plates 250A and 250B. As the jaw set continues to rotate about axis 184 and as the cone line continues to move downstream, the tenderloin 190 is peeled away from the carcass starting from the wishbone end of the tenderloin and then along the keel bone for detachment from the carcass.

Once the tenderloin has been removed from the carcass, the jaw grips 220 and 222 open under the action of the upper and lower cam plates 250A and 250B so that the removed tenderloin can be deposited into a bin, onto a takeaway conveyor, or other location for further processing. It will be appreciated that in this manner, tenderloins 190 are continuously removed (peeled) from carcasses that are being continuously carried along the cone line 120, without damage to the tenderloins.

As schematically depicted in FIG. 1, the control system 300 includes a controller 302 for use in controlling the operation of removal section 106. The control system also includes a processor/computing device 304 linked to the controller. An appropriate interface 306 is provided for connecting dive drum 132, the mounting plate motors 196, and other components and measurement devices, to the controller 302.

A memory unit 308 is provided for storing information, programs, for example, setting for the tenderloin removal assembly 180. Other information in memory can include, for example, the number of tenderloins removed. Further past performance metrics of the machine 100 may be stored in memory as well as maintenance records and schedule for the machine 100.

An input device or interface 310 is provided to enable the operator to communicate with the processor and controller. The interface can be a HUI in the form of a touch screen. The HUI 310 can be used to convey information from the processor or control system to the operator, including the functioning of and operational metrics of the system 100.

The control system 300 can also be used to control the operation of the processing stations 102 and 104 and thereby the operation of the entire machine 100. Further, the control system may be part of a system that controls the operation of processing stations up stream and/or downstream of the machine 100, especially if the operation of the machine 100 is tied to the operation of upstream and/or downstream processing of the poultry.

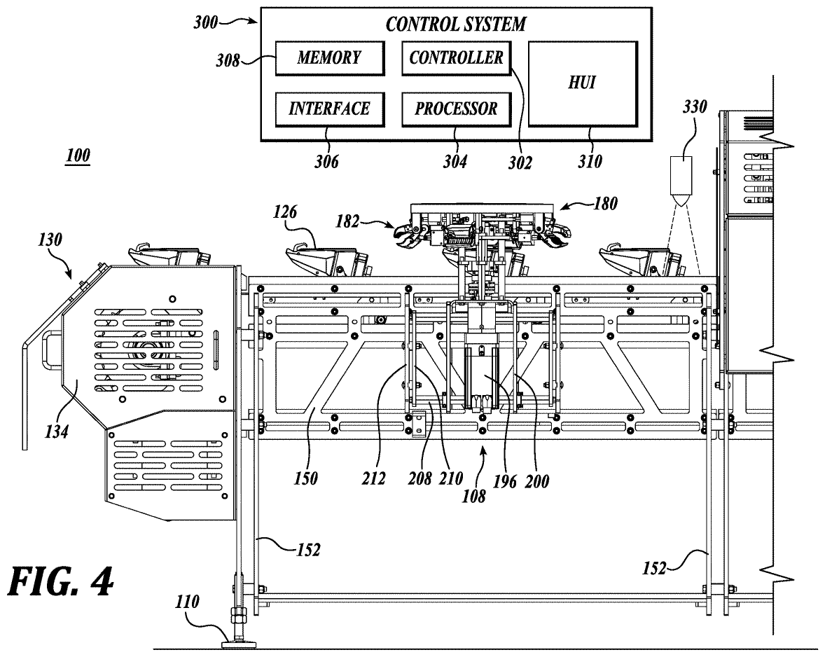

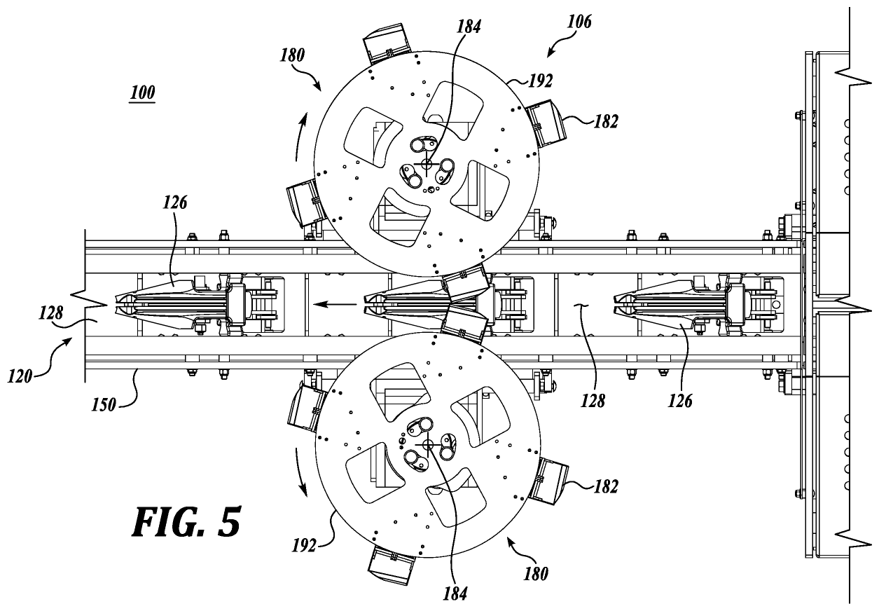

While illustrative embodiments have been illustrated and described, it will be appreciated that various changes can be made therein without departing from the spirit and scope of the invention. For example, a scanner 320, shown schematically in FIG. 4, can be used to view the position and size of the carcass 125 and/or locations and sizes of the tenderloins 190. This information can be used to automatically adjust the position of the jaw sets 182 so that the jaw set is correctly positioned with respect to the tenderloin in question. The data from the scanner 320 can be sent to the control system 300, processed by the control system, and then used to operate the actuators that move the jaw sets toward and away from the longitudinal centerline of the cone line as well as in the vertical direction.

In the above description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well known process steps have not been described in detail in order not to unnecessarily obscure various aspects of the present disclosure. Further, it will be appreciated that embodiments of the present disclosure may employ any combination of features described herein.

The present application may include references to “directions,” such as “forward,” “rearward,” “front,” “back,” “ahead,” “behind,” “upward,” “downward,” “above,” “below,” “horizontal,” “vertical,” “top,” “bottom,” “right hand,” “left hand,” “in,” “out,” “extended,” “advanced,” “retracted,” “proximal,” and “distal.” These references and other similar references in the present application are only to assist in helping describe and understand the present disclosure and are not intended to limit the present invention to these directions.

The present application may include modifiers such as the words “generally,” “approximately,” “about,” or “substantially.” These terms are meant to serve as modifiers to indicate that the “dimension,” “shape,” “temperature,” “time,” or other physical parameter in question need not be exact, but may vary as long as the function that is required to be performed can be carried out. For example, in the phrase “generally circular in shape,” the shape need not be exactly circular as long as the required function of the structure in question can be carried out.

In the above description and in the accompanying drawings, corresponding systems, assemblies, apparatus, and units may be identified by the same part number, but with an alpha suffix. The descriptions of the parts/components of such systems assemblies, apparatus, and units that are the same or similar are not repeated so as to avoid redundancy in the present application.

While illustrative embodiments have been illustrated and described, it will be appreciated that various changes can be made therein without departing from the spirit and scope of the invention.

1. An apparatus for removing tenderloins from a poultry carcass, the carcass being transported by a conveyance system past a processing station where the tenderloins are removed from the carcass, the apparatus comprising:
at least one jaw set;
a mounting structure for supporting the at least one jaw set for moving the at least one jaw set in a continuous arcuate path towards and then away from the poultry carcass; and
an actuator operable on the at least one jaw set to cause the at least one jaw set to be in open configuration when the at least one jaw set moves toward the moving carcass and then to close the at least one jaw set over the tenderloin to detach the tenderloin from the carcass as the at least one jaw set moves away from the carcass while traveling in the continuous arcuate path.

2. The apparatus of claim 1, wherein the mounting structure places the moving at least one jaw set in registry with the poultry tenderloin when the carcass is passing by the processing station.

3. The apparatus of claim 1, wherein the mounting structure moves the at least one jaw set towards the carcass as the carcass approaches the processing station.

4. The apparatus of claim 1, wherein the mounting structure moves the at least one jaw set away from the carcass as the carcass moves away from the processing station.

5. The apparatus of claim 1, wherein the actuator opens the at least one jaw set to release tenderloin that has been grasped by the at least one jaw set and removed from the carcass.

6. The apparatus of claim 1; further comprising a plurality of jaw sets operable to remove tenderloins from respective carcasses.

7. The apparatus of claim 6, wherein the plurality of jaw sets sequentially remove tenderloins from respective carcasses.

8. The apparatus of claim 6, wherein:
the mounting structure continuously pivots about a central axis; and
the jaw sets are disposed radially relative to the central axis.

9. The apparatus of claim 8, wherein the actuator pivots about the central axis to remain in position to be operable on a respective jaw set.

10. The apparatus of claim 8, wherein the jaw sets are spaced about the mounting structure.

11. The apparatus of claim 1, wherein:
the mounting structure pivots about a central axis; and
the at least one jaw set is disposed radially relative to the central axis.

12. The apparatus of claim 11, wherein the actuator pivots about the central axis to remain in position to be operable on the at least one jaw set.

13. The apparatus of claim 12, wherein the actuator includes a cam system and a cam follower system operated on by the cam system to open and close the at least one jaw set.

14. The apparatus of claim 13, wherein:
the cam system is stationary; and
the cam follower system is disposed between the cam system and the at least one jaw set to open and close the jaw as the mounting structure pivots about the central axis.

15. The apparatus of claim 13, wherein:
the at least one jaw set includes a first jaw grip and a second jaw grip; and
the actuator includes a first cam and a first cam follower disposed between the first cam and the first jaw grip to move the first jaw grip toward and away from the second jaw grip.

16. The apparatus of claim 15, wherein the actuator comprises a second cam and a second cam follower disposed between the second cam and the second jaw grip to move the second jaw grip toward and away from the first jaw grip.

17. The apparatus of claim 16, wherein:
the second cam is stationary; and
the second cam follower is mounted on the mounting structure to open and close the second jaw grip as the mounting structure rotates about the central axis.

18. The apparatus of claim 17, wherein:
the first cam is stationary; and
the first cam follower is mounted on the mounting structure to open and close the first jaw grip as the mounting structure rotates about the central axis.

19. The apparatus of claim 16, wherein:
the first cam is stationary; and
the first cam follower is mounted on the mounting structure to open and close the first jaw grip as the mounting structure rotates about the central axis.

20. The apparatus of claim 16, wherein:
the first and second cams are stationary; and
the first and second cam followers are mounted on the mounting structure to open and close the first and second jaw grips, respectively, as the mounting structure rotates about the central axis.

21. An apparatus for removing tenderloins from a poultry carcass, the carcass being transported by a conveyance system past a processing station where the tenderloins are removed from the carcass, the apparatus comprising:
at least one jaw set;
a mounting structure for supporting the at least one jaw set and for moving the at least one jaw set along an arcuate path, towards and then away from the poultry carcass;
an actuator operable on the at least one jaw set to cause the at least one jaw set to be in open configuration when the at least one jaw set moves toward the moving carcass and then to close the at least one jaw set over the tenderloin;
the mounting structure moving the closed at least one jaw set away from the carcass along a continuation of the arcuate path to peel the tenderloin away from the carcass.
